(19) United States
(12) Patent Application Publication
(10) Pub. No.: US 2010/0055279 A1
(43) Pub. Date: Mar. 4, 2010

(54) CONTINUOUS PROCESS FOR PRODUCING A FRUIT AND/OR VEGETABLE PASTE AND A PLANT FOR OPERATING SUCH PROCESS

(76) Inventors: Sander Dubbelman, Vlaardingen (NL); Mark van Dijk, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/514,458

(22) PCT Filed: Oct. 23, 2007
(86) PCT No.: PCT/EP2007/061356

§ 371 Date: May 12, 2009

(30) Foreign Application Priority Data
Nov. 13, 2006 (EP) 06123948.9

(51) Int. Cl. A23L 1/212; A23B 7/02; B01D 1/00; A23B 4/28

(52) U.S. Cl. 426/492; 99/487

(57) ABSTRACT

One aspect of the present invention provides a continuous process for producing a fruit and/or vegetable paste comprising separating a continuous stream of fruit and/or vegetable juice into a low solids serum stream and a high solids pulp stream and concentrating the serum stream in a concentrator before recombining it with the pulp stream to produce a recombined stream; wherein the Brix concentration of the recombined stream is automatically adjusted to a constant level by combining the concentrated serum stream, the pulp stream and/or the recombined stream with an adjustable amount of a diluent stream and by automatically adjusting the flow rate of the diluent stream to compensate for fluctuations in the Brix concentration of the pulp stream and/or the concentrated serum stream. The invention also provides a plant for the production of a fruit and/or vegetable paste that can suitably be used to operate the aforementioned continuous process.

### TECHNICAL FIELD OF THE INVENTION

The present invention provides a novel continuous process for the manufacture of fruit and/or vegetable paste, e.g. tomato paste. The invention also provides a plant for operating such a process.

### BACKGROUND OF THE INVENTION

Tomato paste is a key ingredient in many tomato products, like tomato sauces, tomato ketchup, passata's and tomato purees. Processes for producing tomato paste have been described extensively in the prior art, for instance by W. A. Gould, “Tomato Production, Processing & Technology”, CTI Publications, (1992).

An alternative process for the production of tomato paste, using a continuous split stream process, has been described in WO 03/024243. This split stream process employs a liquid/solid separation device for partial or complete removal of non-dissolved components from the tomato juice starting material, thus yielding a high solids pulp stream and a low solids serum stream. The tomato serum stream is subsequently concentrated with more ease because the viscosity of this tomato serum is lower than that of normal tomato juice. The lower viscosity also enables the use of alternative concentration equipment that would normally not function efficiently with tomato juice. This equipment includes falling film evaporators, plate evaporators, rising film evaporators, rising falling film evaporators, cryoconcentrators and reverse osmosis or combinations thereof. The resulting concentrated serum is recombined with the tomato pulp from the liquid/solid separation device to yield a superior quality tomato paste. This recombination can take place in different ways as described by WO 03/024243, e.g. before or after sterilisation. Also, one or both fractions can be (further) concentrated before being recombined. A drawback of the process described in WO 03/024243 resides in the fact that it cannot be used to produce a combined stream with a constant Brix level and/or Bostwick value, unless part of the pulp stream or serum stream is discarded.

Tomato paste is produced according to generally accepted industry standards:
The Brix (defined as the amount of soluble solids divided by the sum of soluble solids and water) of a tomato paste can be maximum 1 Brix higher or 1 Brix lower than the stated Brix of the tomato paste. The Brix value of tomato paste can vary within a broad range depending, for instance, on whether the paste was obtained through hot break or cold break. Usually the Brix value of tomato paste is within the range of 10-40 Brix.
The Bostwick value is typically maximum 1 cm Bostwick higher or 1 cm Bostwick lower than stated Bostwick of the tomato paste. The Bostwick of a product can be determined as follows. Dilute the product to 12 Brix and mix until there are no visible lumps. Place the diluted product sample in a viscometer instrument called a Bostwick Consistometer. The Bostwick Consistometer must be at room temperature (25° C.) and be clean and dry. Furthermore, it must be leveled. Make sure that the sample chamber is completely filled. Scrape off the excess material of the top of the chamber with a straight edge. Release the gate and time for 30 seconds. Record the distance the sample has traveled in cm. The sample will move to a distance corresponding to its viscosity; the higher the viscosity, the less distance the sample will move. The Bostwick number is obtained by measuring the distance in centimeters as calibrated on the instrument. The Bostwick value of tomato paste typically is within the range of 3-12 cm.

These specifications can easily be met using a standard continuous process for the production of tomato paste as described by Gould because the control of such processes is straightforward and well established.

Surprisingly little is known about the quality characteristics of tomato paste produced in a split stream process as described above. We have found that it is difficult to control such processes towards the industry standards described above. This can be explained by making a steady state mass balance over the system of liquid/solid separator, concentrator, and recombinator. Since the quantity of soluble solids (Brix) and insoluble solids in tomato juice fluctuates, it can readily be seen that the soluble solids content and insoluble solids content of the tomato paste will fluctuate. The inventors have found that the Brix concentration of the tomato paste obtained from the split stream process fluctuates with an amplitude of more than 2 Brix points around its average. Because the viscosity of tomato products depends on the level of insoluble solids, fluctuations in insoluble solids content will also cause fluctuations in Bostwick of up to 3 cm Bostwick around the average.

Based on the above, it is well understood that a proper control of continuous processes is critical to achieve the best product quality at the highest processing capacity and with the least amount of energy consumption. It is easily understood that at throughputs of 10 to 100 ton/hr of fresh tomatoes the production of tomato paste out of specification as a result of process fluctuations can be very costly. This is why an adequate control of continuous tomato processes and the resulting products is of paramount importance.

### SUMMARY OF THE INVENTION

The inventors have developed a continuous split stream process for the production of fruit and/or vegetable paste that has been set up in such a way as to enable accurate control of the Brix concentration of the resulting paste product. Unlike the process described in WO 03/024243 accurate control of the Brix concentration can be achieved without generating waste streams and without having to use large buffer tanks. These benefits of the present invention are achieved by employing an additional stream, i.e. a diluent stream, which is combined with the concentrated serum stream, the pulp stream and/or the recombined stream. The benefits of the present invention may be achieved by combining the aforementioned diluent stream with the recombined stream. However, it is equally possible to achieve these same benefits by combining the diluent stream with the pulp stream and/or the concentrated serum stream. For simplicities sake, in the next few paragraphs the benefits of the invention will be explained by referring to a continuous split stream process in which the diluent stream is combined with the recombined stream.

The use of the diluent stream in the present process makes it possible to compensate for the fluctuations in Brix concentration that occur in the recombined stream of the split stream process described herein before. To this end the flow rate of the diluent stream is continuously and automatically adjusted in response to input parameters that are indicative of the Brix concentrations of the pulp stream and/or the concentrated serum stream and/or the recombined stream. Because the Brix concentration of the diluent stream is lower than the Brix concentration of the recombined stream, it is possible to dilute to a constant Brix concentration by increasing the flow rate of the diluent stream if the Brix concentration of the recombined stream is rising or if it has been calculated from the Brix concentrations of the other streams (i.e. juice stream, pulp stream and/or concentrated serum stream) that the Brix concentration of the recombined stream is rising. Likewise, the flow rate of the diluents stream is decreased if the (calculated) Brix concentration of the recombined stream is declining.

The present method offers the advantage that it is fast and very robust. Furthermore, the present method offers the important benefit that constant product quality can be achieved, despite fluctuations in raw material quality, without having to manipulate the throughput and/or operating conditions of the separator and/or concentrator.

### DEFINITIONS

The “hold-up volume” refers to the total volume of processed material that is contained within a certain device.
The term “recombination ratio” as used herein refers to the weight ratio in which the pulp stream and the concentrated serum stream are combined in the recombinator.
The term “automatic controller” as used herein refers to an electronic or pneumatic appliance that is capable of controlling the operating conditions of a mechanical device, e.g. a pump or a valve, in response to a variable input signal, such as a signal produced by an electronic sensor. Preferably, the automatic controller employed in accordance with the present invention is a programmable computer.

### BRIEF DESCRIPTION OF THE DRAWINGS

FIG. 1 is a schematic illustration of a juice processing plant using a process control scheme in accordance to the present invention.

FIG. 2 is a schematic illustration of a juice processing plant comprising a concentrator unit that uses a process control scheme in accordance with a preferred embodiment of the present invention.

FIGS. 3a-3e contain graphs depicting the variations in flow rate and Brix concentration observed in a split stream process that produces tomato paste from tomato juice without using a diluent stream. FIGS. 3a and 3c depict the flow rates of the juice stream and the concentrated serum stream respectively. FIGS. 3b, 3d and 3e show the Brix concentrations of the juice stream, the concentrated stream and the recombined stream.

FIGS. 4a-4f contain graphs depicting the variations in flow rate and Brix concentration observed in a split stream process that does employ a diluent stream. FIGS. 4a and 4c depict the flow rates of the juice stream and the concentrated serum stream respectively. FIGS. 4b, 4d and 4f show the Brix concentrations of the juice stream, the concentrated stream and the recombined stream. FIG. 4e shows how the flow rate of the diluent stream was adjusted over time in order to control the Brix concentration of the recombined stream.

### DETAILED DESCRIPTION OF THE INVENTION

Thus, one aspect of the present invention provides a continuous process for producing a fruit and/or vegetable paste using a separator, a concentrator and a recombinator, the process comprising:
a. providing a continuous stream of fruit and/or vegetable juice to the inlet of the separator;
b. separating the juice stream in the separator into a low solids serum stream and a high solids pulp stream;
c. transferring the serum stream through a serum outlet of the separator to the inlet of the concentrator;
d. concentrating the serum stream in the concentrator;
e. transferring the concentrated serum stream through an outlet of the concentrator to a serum inlet of the recombinator;
f. transferring the pulp stream through a pulp outlet of the separator to a pulp inlet of the recombinator;
g. recombining the concentrated serum stream and pulp stream in the recombinator;
h. transferring the recombined stream through an outlet of the recombinator to another processing unit for further processing;
   wherein the Brix concentration of the recombined stream is automatically adjusted to a constant level by combining the concentrated serum stream, the pulp stream and/or the recombined stream with an adjustable amount of a diluent stream and by automatically adjusting the flow rate of the diluent stream to compensate for fluctuations in the Brix concentration of the pulp stream and/or the concentrated serum stream.

The benefits of the present process can be realised in the production of a variety of fruit and/or vegetable pastes, e.g. tomato paste, fruit concentrate, etc. According to a particularly preferred embodiment, the fruit and/or vegetable juice employed as a starting material in the present method is tomato juice. Preferably, the tomato juice used in the present continuous process is also produced continuously by hot or cold breaking tomatoes and continuously transferred from the hot or cold break to the separator, optionally after removal of solids (e.g. seed and/or tomato skin) and/or after an initial concentration operation.

In the present method the Brix concentration of the recombined stream can be adjusted to a constant level by combining the diluent stream with the concentrated serum stream, the pulp stream and/or the recombined stream. The diluent stream employed in the present process is different from the other streams employed in the present process, i.e. the concentrated serum stream, the pulp stream and the recombined stream. According to a preferred embodiment, the Brix level of the recombined stream is adjusted by combining the diluent stream with the recombined stream. The latter embodiment offers the advantage that the Brix concentration of the paste product can be controlled even more accurately. Furthermore, this embodiment offers the benefit of a faster control response time.

The diluent stream employed in the present process should be compatible with the paste product that is produced in the process. The diluent stream may consist of water, e.g. part of the aqueous stream that is obtained from the concentrator. According to a particularly preferred embodiment, however, the diluent stream is a stream of the same fruit and/or vegetable juice as is provided to the inlet of the separator. By employing a diluent stream that is identical to the juice stream that is fed to the separator, it is ensured that the risk of e.g. flavour and colour variations is minimised.

In the present process, the juice stream typically has a concentration of 3-12 Brix. In case the juice stream is obtained from a fruit such as tomato the juice stream usually has a concentration of 3.5-5.5 Brix. Preferably, the juice stream has a concentration of 4.0-5.5 Brix, most preferably of 4.5-5.5 Brix. The insoluble solids content of the juice stream preferably is within the range of 0.05-2 wt. %, more preferably within the range of 0.5-1.5 wt. % and most preferably within the range of 0.8-1.0 wt. %.

In the separator the juice stream is separated into a high solids pulp stream and a low solids serum stream. Generally, these two streams are generated in the separator in a weight ratio of 5-15 parts pulp stream to 95-85 parts serum stream. Generally, the insoluble solids content of the high solids stream is within the range of 3-15 wt. %, preferably within the range of 5-10 wt. %. The insoluble solids content of the high solids stream typically is at least 80% higher than that of low solids serum stream. Preferably, insoluble solids content of the pulp stream is at least 4 times, more preferably at least 6 times higher than the insoluble solids content of the serum stream.

The concentrator employed in the present process removes water from the serum stream and thereby increases the Brix concentration of the serum stream. Typically, the Brix concentration of the concentrated serum stream coming out of the concentrator is at least 600%, more preferably at least 800% higher than the Brix concentration of the serum stream coming out of the separator. Most preferably, the Brix concentration of the concentrated serum stream is between 700% and 900% higher than the Brix concentration of the serum stream.

The concentrated serum stream typically has a concentration of at least 10 Brix, preferably of at least 20 Brix. Even more preferably, the concentrated serum stream has a concentration of 35-75 Brix and most preferably of 40-50 Brix. According to another preferred embodiment the Brix concentration of the concentrated serum stream is at least 30 units higher than the Brix concentration of the juice stream.

In order to obtain a product of optimum quality it is preferred that both the residence time of the serum stream between the separator and the recombinator and the residence time of the pulp stream between the separator and the recombinator are as short as possible. Typically, both these residence times do not exceed 50 minutes, preferably they do not exceed 40 minutes and most preferably they do not exceed 30 minutes.

In the present process, the pulp stream typically represents 5-20 wt. % of the juice stream that is separated in the separator. Preferably, the latter percentage is within the range of 8-17 wt. %, more preferably within the range of 10-15 wt. %. Furthermore, the pulp stream obtained from the separator typically has a concentration of at least 4.5 Brix. Optionally, the pulp stream coming out of the separator may be concentrated before being recombined with the concentrated serum stream. Preferably, the pulp stream is not concentrated before being recombined with the concentrated serum stream.

According to a particularly preferred embodiment, all of the insoluble solids and soluble solids contained in the juice stream that is separated in the separator is still contained in the stream obtained by recombining the concentrated serum stream and the pulp stream. In other words, in accordance with this preferred embodiment the only side-stream generated in the process between the separator and the recombinator is the water stream coming out of the concentrators.

The diluent stream employed in the present process typically has a concentration of less than 10 Brix. Preferably, the diluent stream has a concentration of 0-8 Brix, more preferably of 2-6 Brix and most preferably of 4.5-5.5 Brix.

In the present process the Brix concentration of the recombined stream is advantageously adjusted to a constant level within the range of 15.5 to 35.5 Brix, preferably of 17.5 to 28.5 Brix and most preferably of 22.5 to 23.5 Brix.

The present process may employ any separator that can suitably be used to achieve a liquid solids separation at high throughput. Examples of such separators include: decanters, centrifuges, screw presses, turbo filters, band filters and combinations thereof. According to a preferred embodiment of the invention the separator employed is a decanter, preferably a decanter that is operated at constant differential speed.

The concentrator employed in the present process may be any concentrating unit that is capable of reducing the water content of a liquid feed at high throughput. Examples of suitable concentrators include evaporators, reversed osmosis units and combinations thereof. Preferably, the concentrator employed in the present process includes one or more evaporators.

The recombinator of the present process can suitably be chosen from a large group of mixing devices, including mixing tanks, in-line static mixers, in-line dynamic mixers etc. Preferably, the recombinator is a stirred mixing tank.

In the present process the flow rate of the diluent stream is advantageously automatically adjusted in response to changes in the Brix concentration of the juice stream, the pulp stream, serum stream, the concentrated serum stream and/or recombined stream. The changes in the Brix concentration of these streams may suitably be determined by any analytical method that is capable of quantitatively monitoring variations in a parameter that is indicative of the Brix concentration. Thus, said analytical parameter may suitably be used as one of the input parameters for the automatic controller that determines the flow rate of the diluent stream.

According to a particularly preferred embodiment, the flow rate of the diluent stream is automatically adjusted in response to changes in the Brix concentration of the pulp stream, the serum stream, the concentrated serum stream and/or the recombined stream. Because the response time for adjusting the flow rate of the diluent stream can be very short, fluctuations in the Brix concentrations of the latter streams can be dampened very effectively by altering the flow rate of the diluent stream, especially if said diluent stream is combined with the recombined stream.

Despite the automatic adjustment of the Brix level of the recombined stream as described herein before fluctuations in product quality may be observed at times, e.g. insoluble solids content and/or Bostwick value. The inventors have discovered that these fluctuations are strongly related to fluctuations in the flow rate and/or composition of the juice stream. In particular if the juice stream is generated in a continuously operated tomato processing plant, such fluctuations cannot be avoided.

According to an advantageous embodiment, the concentrator employed in the present process comprises (i) a buffer feed tank comprising an inlet and an outlet, said inlet being connected to the serum outlet of the separator and (ii) a sequence of one or more evaporators, the inlet of the first evaporator being connected to the outlet of the buffer feed tank and the outlet of the last evaporator being connected to the serum inlet of the recombinator.

Unexpectedly, it was found that the adverse effects of fluctuations in the flow rate of the juice stream may be minimised in a very effective manner by ensuring that independently the hold-up volume within the buffer feed tank and each of the one or more evaporators are maintained at a constant level, be it that the hold-up volume is allowed to vary within a certain range. By allowing the hold-up volumes to vary slightly, so called flow dampening can be achieved, resulting in a stable flow through the decanter, buffer tank and evaporators. A stable flow offers the advantage that product quality and the process itself can be controlled more easily and effectively.

Advantageously this independent level control is achieved by automatically adjusting the flow rate of the juice stream in response to a change in hold-up volume within the buffer feed tank and by automatically adjusting the flow rate of the serum stream into the one or more evaporators in response to a change in hold-up volume within said one or more evaporators. By automatically adjusting the flow rate of the juice stream into the decanter in response to a change in hold-up volume in the buffer feed tank, it is ensured that the change in hold-up volume of the buffer feed tank is negated. Although independent, there is a strong interaction between the level control loops employed in the present process (dynamic behaviour). Thus, the independent automatic level control of the buffer feed tank and the one or more evaporators ensures that the complete concentrator operation remains in balance. In practice, this means that the present process can be operated continuously for several weeks. Consequently, this embodiment of the present invention not only offers the advantage of yielding a product of constant quality without any waste streams, but it also provides a process that can run uninterruptedly without any manual interventions for several weeks.

According to a particularly preferred embodiment, the concentrator employed in the present process comprises two or more evaporators, most preferably three or more evaporators. As mentioned herein before, advantageously the hold-up volume within each of these evaporators is automatically kept at a constant level by controlling the inflow into said evaporators in response to fluctuations in said hold-up volume.

According to another particularly preferred embodiment, also the hold-up volume within the recombinator is automatically maintained at a constant level by controlling the outflow from said recombinator in response to fluctuation in said hold-up volume. By controlling the hold-up volumes within all the unit operations of the concentrator as well as the hold-up volume within the recombinator in the manner described herein, an extremely stable process can be realised that can run continuously without manual interventions for several weeks or longer.

A major advantage of the present process resides in the fact that it can be operated in a continuous uninterrupted fashion for a period of at least 1 day, preferably at least 1 week and most preferably at least 2 weeks during which period, thanks to the readjustment with the diluent stream, the Brix concentration of the recombined stream is controlled to fluctuate with an amplitude that does not exceed 2 Brix. Even more preferably, said amplitude does not exceed 1 Brix and most preferably it does not even exceed 0.5 Brix. Additionally, the present process offers the advantages that during these same periods, the Bostwick value of the recombined stream can be controlled to fluctuate with an amplitude that does not exceed 2 cm, more preferably with an amplitude that does not exceed 1 cm.

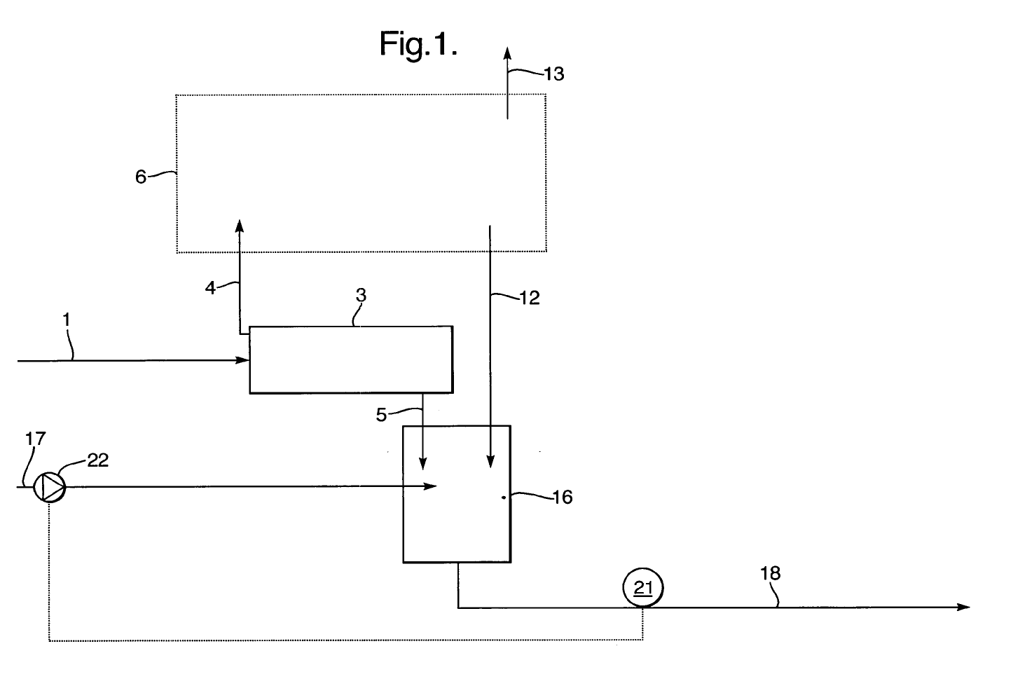

FIG. 1 provides a schematic representation of a process according to the present invention wherein a tomato juice stream is converted into tomato paste. The tomato juice stream 1 is produced in a continuous fashion in a manner known per se, including the steps of chopping, breaking and screening. The tomato juice stream 1 typically has a concentration of 4.5-5.5 Brix and is separated in decanter 3 into 85-90 wt. % of a low solids serum stream 4 and 10-15 wt. % of a high solids pulp stream 5. The high solids pulp stream 5 typically has an insoluble solids content of 7-9 wt. %. The low solids serum stream 4 is concentrated in the concentrator 6, yielding a concentrated serum stream 12 and a water vapour stream 13. The concentrated serum stream 12 typically has a concentration of 40-45 Brix. The concentrated serum stream 12 and the high solids pulp stream 5 are fed into a stirred mixing vessel 16, together with a stream of tomato juice 17 (the diluent stream). The composition of the tomato juice stream 17 is essentially the same as that of tomato juice stream 1. The three streams are thoroughly mixed in the mixing vessel 16 and leave the vessel as tomato paste 18. The paste stream 18 passes a sensor 21 that measures the Brix concentration of said stream 18. The output of sensor 21 is used to control the flow rate through pump 22. If the sensor detects that the Brix concentration of the paste stream 18 exceeds a predetermined target value, the flow rate through pump 22 is increased. If the sensor detects that the Brix concentration if below the predetermined target value, the flow rate through pump 22 is decreased. Typically, the latter control loop maintains the Brix concentration of the tomato paste stream 18 with a range of 22.5-23.5 Brix.

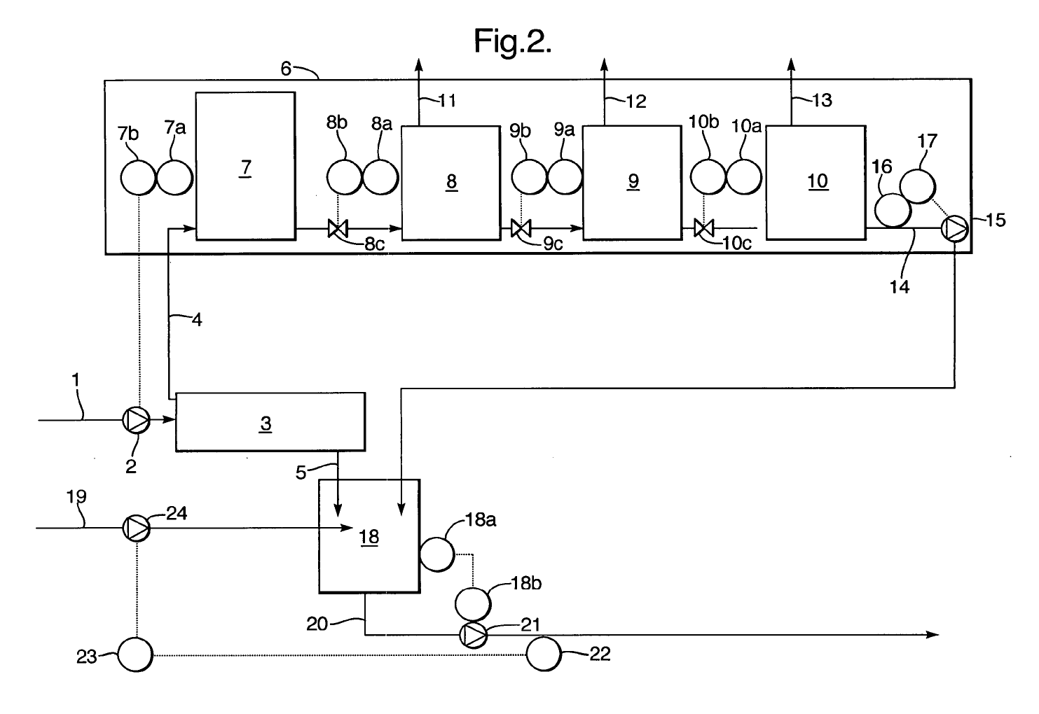

FIG. 2 depicts a preferred embodiment of the process described above in relation to FIG. 1. Again, the tomato juice stream 1 is fed by pump 2 into decanter 3, where it is separated into a low solids serum stream 4 and a high solids pulp stream 5. The low solids serum stream 4 is concentrated in the concentrator 6, yielding a concentrated serum stream 14 and water vapour streams 11, 12 and 13. The concentrator 6 comprises a buffer feed tank 7, a first evaporator 8, a second evaporator 9, a third evaporator 10. The buffer feed tank 7 is equipped with a level sensor 7a that is connected to pump 2 through a level controller 7b. The flow rate through the pump 2 is determined by the output from the level controller 7b. Thus, if the level sensor 7a detects an increase in the hold-up volume of the buffer feed tank 7 the signal generated by sensor 7a will (through the controller) cause the pump 2 to decrease the flow rate of the tomato juice stream 1 and vice versa. The evaporators 8, 9 and 10 are equipped with level sensors 8a, 9a and 10a and level controllers 8b, 9b and 10b. Furthermore, the inlets of the evaporators 8, 9 and 10 comprise valves 8c, 9c and 10c. The flow rate through the valve 8c is controlled by the level controller 8b of the first evaporator 8. Thus, if the level sensor 8a detects an increase in the hold-up volume of the first evaporator 8, the signal generated by sensor 8a will (through the controller 8b) cause the valve 8c to decrease the flow rate through said valve and vice versa. The valves 9c and 10c are controlled in exactly the same fashion by the level controllers 9b and 10b. The concentrated serum stream 14 is fed by pump 15 to the mixing vessel 18. The flow rate through pump 15 is controlled by the output signal of controller 17 as fed by sensor 16 which determines the Brix concentration of the concentrated serum stream 18. If the Brix concentration detected by sensor 16 exceeds the predetermined target value, the flow rate through the pump 15 is increased by the controller 17. If the Brix concentration is below the target value, the flow rate through the pump 15 is decreased by the controller 17. In the mixing vessel 18 the concentrated serum stream 14 is combined with the high solids pulp stream 5 and a stream of tomato juice 19. The composition of the tomato juice stream 19 is essentially the same as that of tomato juice stream 1. The three streams are thoroughly mixed in the mixing vessel 18 and leave the vessel as tomato paste 20. The mixing vessel 18 is equipped with a level sensor 18a and level controller 18b which controls the flow rate through pump 21 which is positioned in the outlet of the mixing vessel 18. The flow rate through the pump 21 is increased by the controller 18b if the sensor 18a detects an increase in hold-up volume or decreased by the controller 18b in case the sensor 18a detects a decrease in hold-up volume. The paste stream 20 exits the pump 21 passes a sensor 22 that measures the Brix concentration of said stream 20. The output of sensor 22 is used to control the flow rate through pump 24 through Brix controller 23. If the sensor detects that the Brix concentration of the paste stream 20 exceeds a predetermined target value, the flow rate through pump 24 is increased through Brix controller 23. If the sensor detects that the Brix concentration is below the predetermined target value, the flow rate through pump 24 is decreased through Brix controller 23.

Another aspect of the invention relates to a plant for the continuous production of a fruit and/or vegetable paste comprising:
a first pump comprising an inlet and an outlet;
a separator comprising an inlet that is connected to the outlet of the first pump, a high solids outlet and a low solids outlet,
a concentrator comprising an inlet and an outlet, said inlet being connected to the low solids outlet of the separator;
a second pump comprising an inlet and an outlet;
a recombinator comprising a pulp inlet that is connected to the high solids outlet of the separator, a serum inlet that is connected to the outlet of the concentrator, a dilution inlet that is connected to the outlet of the second pump, and an outlet;
an automatic controller in communication with the second pump;
a Brix concentration monitor in communication with the automatic controller;
   wherein the controller automatically adjusts the throughput of the second pump in response to the output of the Brix concentration monitor.

In the aforementioned configuration of a plant for carrying out the process according to the present invention, the pulp stream, the serum stream as well as the diluent stream are combined in the recombinator. However, the benefits of the present invention can also be realised by first combining the pulp stream and the serum stream in the recombinator and by subsequently combining the recombined streams with the diluent stream. Consequently, an alternative embodiment of the invention relates to a plant for the continuous production of a fruit and/or vegetable paste comprising:
a first pump comprising an inlet and an outlet;
a separator comprising an inlet that is connected to the outlet of the first pump, a high solids outlet and a low solids outlet,
a concentrator comprising an inlet and an outlet, said inlet being connected to the low solids outlet of the separator;
a recombinator comprising a pulp inlet that is connected to the high solids outlet of the separator, a serum inlet that is connected to the outlet of the concentrator and an outlet;
a second pump comprising an inlet and an outlet;
a dilutor comprising: a first inlet that is connected to the outlet of the recombinator, a second inlet that is connected to the outlet of the second pump, and an outlet;
an automatic controller in communication with the second pump;
a Brix concentration monitor in communication with the automatic controller;
   wherein the controller automatically adjusts the throughput of the second pump in response to the output of the Brix concentration monitor.

According to a preferred embodiment of the aforementioned plant configurations, the Brix concentration monitor is positioned downstream of the recombinator, preferably near the outlet of the recombinator. This particular embodiment offers the advantage that it is effective as well as simple and robust. Alternative embodiments, in which the Brix concentration of the (concentrated) serum stream and/or the Brix concentration of the pulp stream are used to control the diluent stream are also possible, but these embodiments are less reliable and/or more complex.

According to yet another preferred embodiment, the concentrator comprises:
a buffer feed tank comprising an inlet and an outlet, said inlet being connected to the serum outlet of the separator; and
a sequence of one or more evaporators, the inlet of the first evaporator being connected to the outlet of the buffer feed tank and the outlet of the last evaporator being connected to the serum inlet of the recombinator;
   wherein the buffer feed tank comprises a level sensor in communication with the automatic controller and wherein the controller automatically adjusts the throughput of the first pump in response to the output of the level sensor.

In an even more preferred embodiment of the latter configuration, the inlet of each of the one or more evaporators comprises a valve and said one or more evaporators each comprise a level sensor in communication with the automatic controller, wherein the controller automatically adjusts the flow rate through the valves in response to the output of the level sensor from the evaporator immediately downstream of said valve.

### EXAMPLES

### Example 1

### Comparative Example

### Split Stream Process without Diluent Stream

Tomato paste was produced from tomato juice on factory scale using a split stream process. Flow rates and Brix concentrations of different streams within the process were monitored simultaneously during a period of 22 hours.

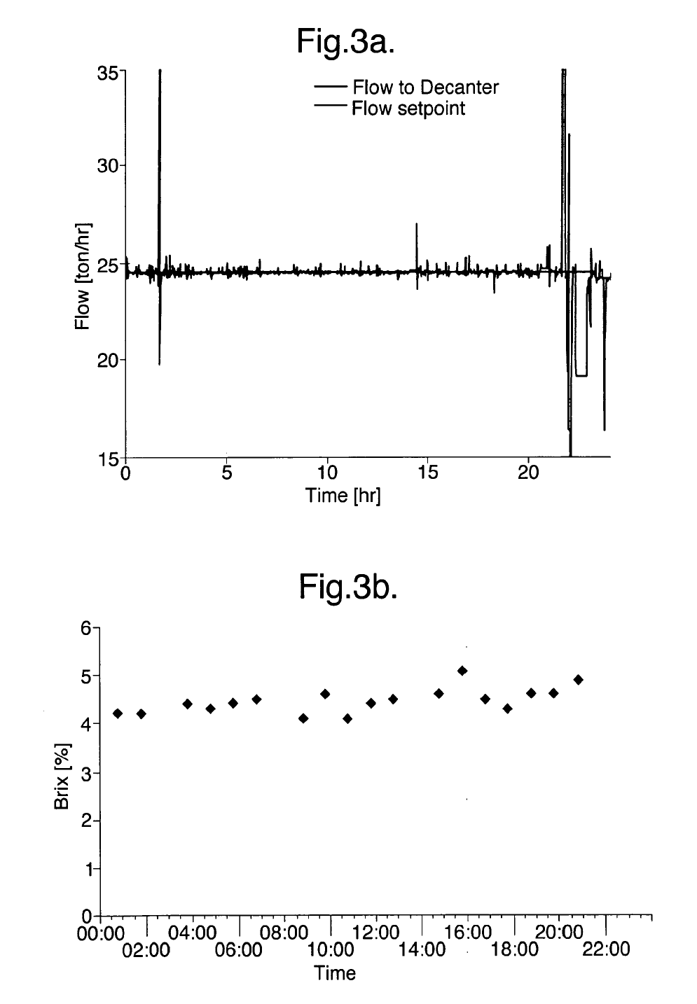

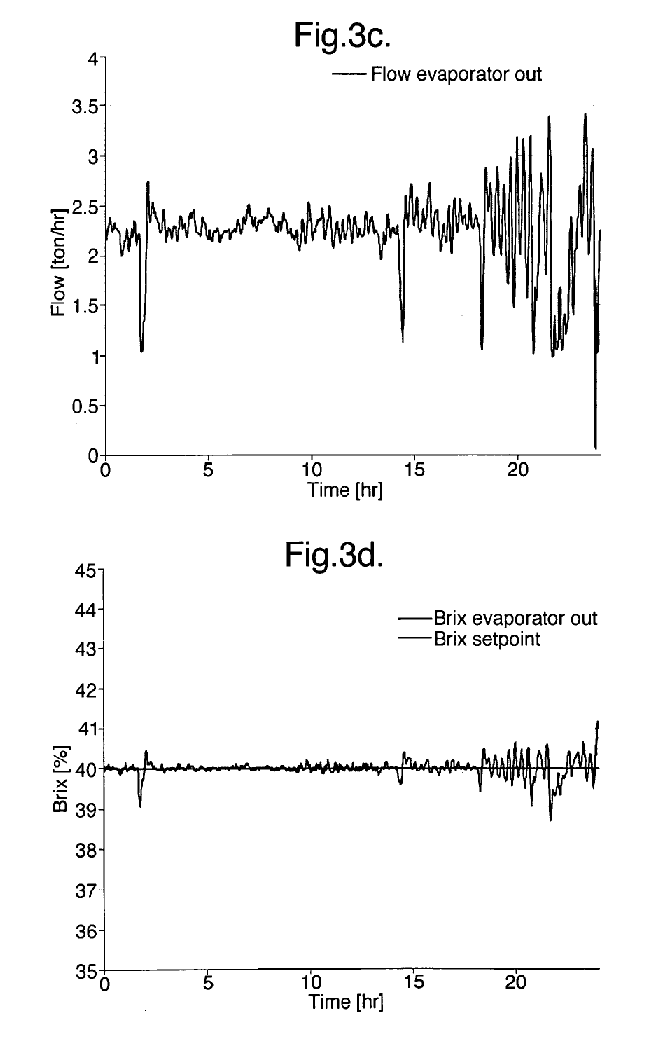

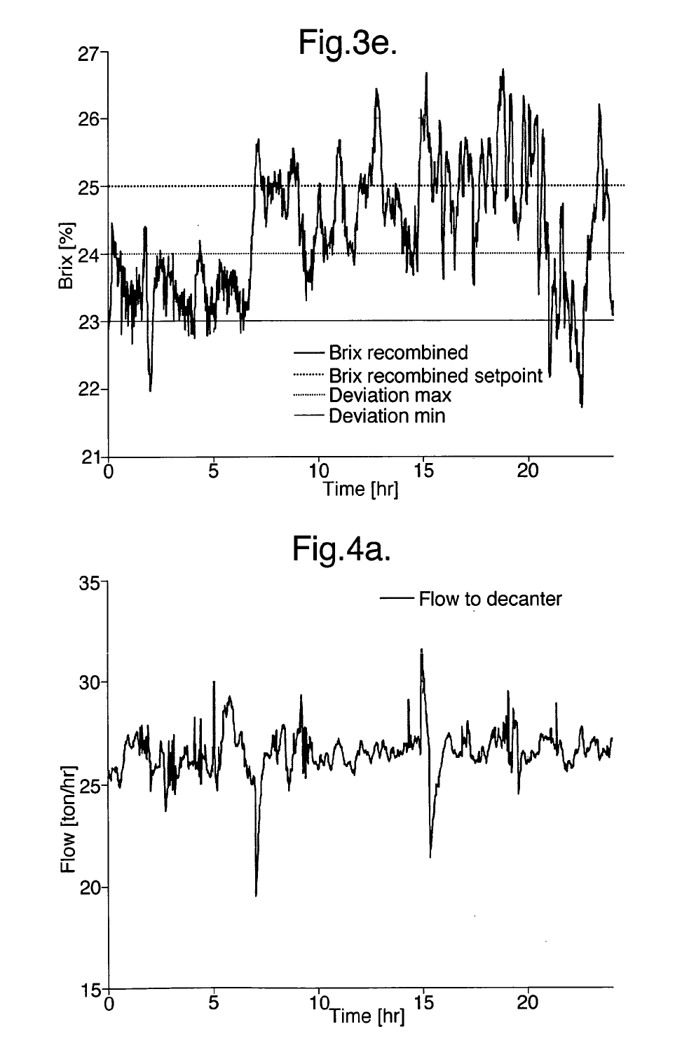

A tomato juice stream was produced in a continuous fashion. The flow rate and Brix concentration of the juice stream were monitored and are depicted in FIGS. 3a and 3b respectively. The low solids serum stream coming out of a Westfalia CA 755 decanter (operated at 2500 RPM and a differential speed of 8 rpm) was continuously concentrated in a Rossi & Catelli T60 evaporator, yielding a concentrated serum stream. The fluctuations in flow rate and Brix concentration of the concentrated serum stream are depicted in FIGS. 3c and 3d. The concentrated serum stream coming out of the evaporator was continuously combined in a stirred mixing vessel with the high solids pulp stream coming out of the aforementioned decanter. The Brix concentration of the recombined stream was continuously monitored and is depicted in FIG. 3e.

FIG. 3e clearly shows that the Brix concentration of the recombined stream fluctuates considerably around the setpoint of 24%. As a matter of fact the maximum allowable deviation of ±1% Brix is repeatedly exceeded during the monitoring period.

### Example 2

### Split Stream Process Using Diluent Stream

Tomato paste was produced on factory scale from tomato juice in a similar fashion (Using the same decanter (but operated at 2700 RPM and a differential speed of 10 rpm) and evaporator) as described in Example 1, except that this time, a diluent stream consisting of tomato juice was continuously introduced in the stirred mixing vessel together with the concentrated serum stream and the high solids pulp stream. Flow rates and Brix concentrations of different streams within the process were monitored simultaneously.

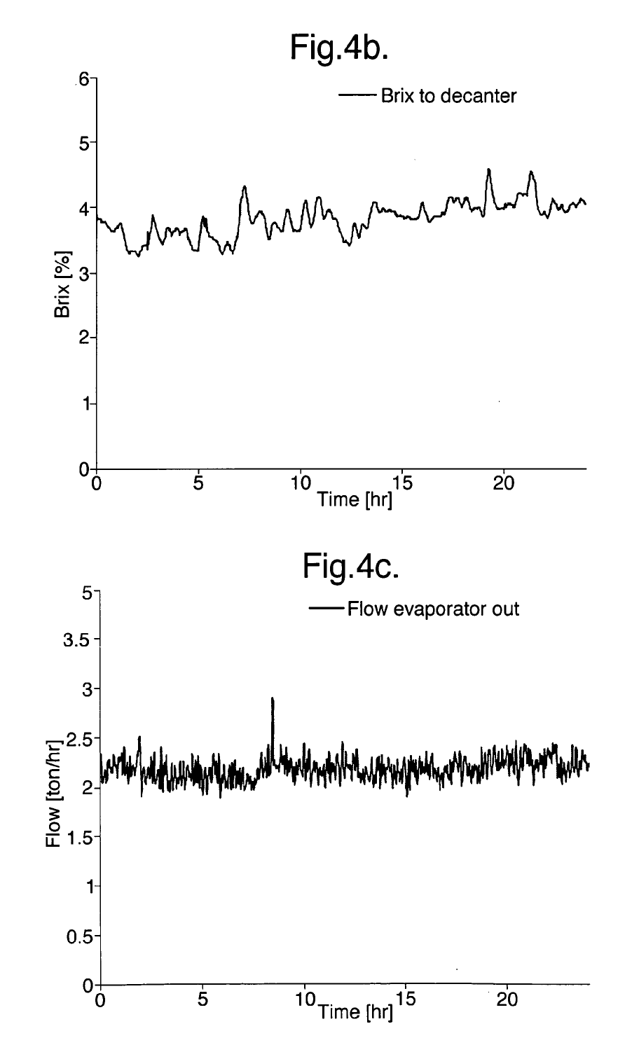

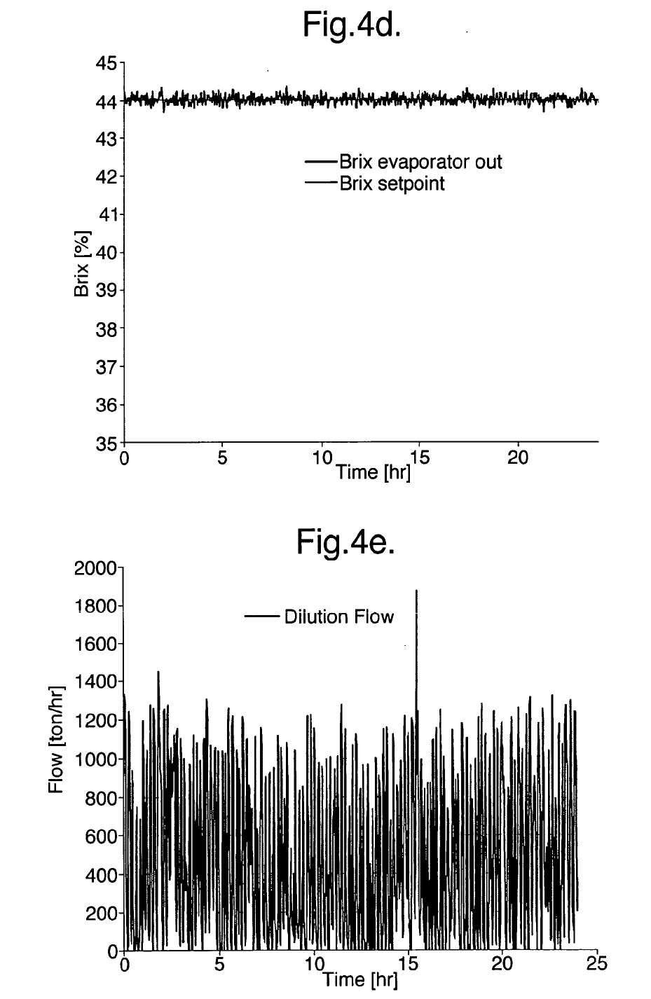

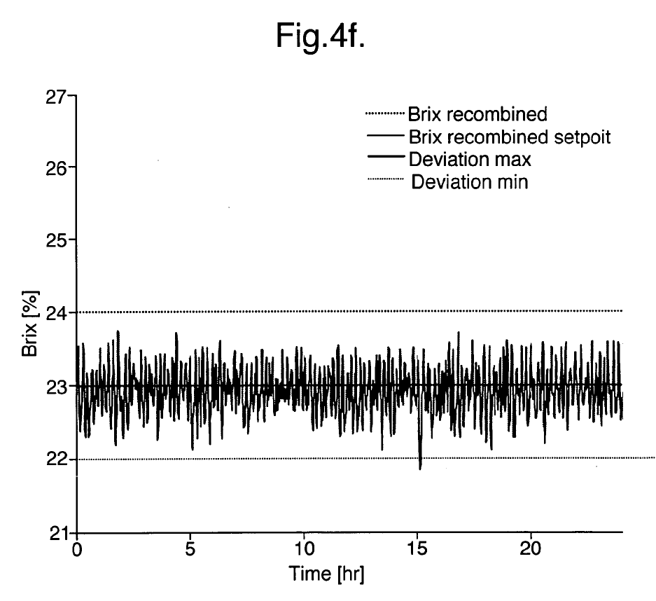

The flow rate and Brix concentration of the juice stream and the concentrated serum stream were monitored for 14 hours. The results are depicted in FIGS. 4a, 4b, 4c and 4d.

FIG. 4e shows how the flow rate of the diluent stream was adjusted in response to measured fluctuations in the Brix concentration of the combined stream.

FIG. 4f shows that by adjusting the flow rate of the diluent stream fluctuations in the Brix concentration of the recombined stream can be minimised very effectively. As a matter of fact in this particular trial the fluctuations remained well within the range that warrants that the resulting product will be within specification

1. A continuous process for producing a fruit and/or vegetable paste using a separator, a concentrator and a recombinator, the process comprising:
a. providing a continuous stream of fruit and/or vegetable juice to the inlet of the separator;
b. separating the juice stream in the separator into a low solids serum stream and a high solids pulp stream;
c. transferring the serum stream through a serum outlet of the separator to the inlet of the concentrator;
d. concentrating the serum stream in the concentrator;
e. transferring the concentrated serum stream through an outlet of the concentrator to a serum inlet of the recombinator;
f. transferring the pulp stream through a pulp outlet of the separator to a pulp inlet of the recombinator;
g. recombining the concentrated serum stream and pulp stream in the recombinator;
h. transferring the recombined stream through an outlet of the recombinator to another processing unit for further processing;
wherein the Brix concentration of the recombined stream is automatically adjusted to a constant level by combining the concentrated serum stream, the pulp stream and/or the recombined stream with an adjustable amount of a diluent stream and by automatically adjusting the flow rate of the diluent stream to compensate for fluctuations in the Brix concentration of the pulp stream and/or the concentrated serum stream.

2. A process according to claim 1, wherein the fruit and/or vegetable juice is tomato juice.

3. Process according to claim 1, wherein the Brix level of the recombined stream is automatically adjusted by combining the recombined stream with the diluent stream.

4. Process according to claim 1, wherein the diluent stream is a stream of the same fruit and/or vegetable juice as is provided to the inlet of the separator.

5. Process according to claim 1, wherein the juice stream has a concentration of 3-12 Brix.

6. Process according to claim 1, wherein the Brix concentration of the recombined stream is automatically adjusted to a constant level within the range of 15.5 to 35.5 Brix.

7. Process according to claim 1, wherein the separator is a decanter that is operated at constant rpm.

8. Process according to claim 1, wherein the flow rate of the diluent stream is automatically adjusted in response to changes in the Brix concentration of the juice stream, the pulp stream, the serum stream, the concentrated serum stream and/or the recombined stream.

9. Process according to claim 8, wherein the flow rate of the diluent stream is automatically adjusted in response to changes in the Brix concentration of the pulp stream, the concentrated serum stream and/or the recombined stream.

10. Process according to claim 1, wherein the concentrator comprises (i) a buffer feed tank comprising an inlet and an outlet, said inlet being connected to the serum outlet of the separator and (ii) a sequence of one or more evaporators, the inlet of the first evaporator being connected to the outlet of the buffer feed tank and the outlet of the last evaporator being connected to the serum inlet of the recombinator.

11. Process according to claim 10, wherein independently the hold-up volume within the buffer feed tank and each of the one or more evaporators are maintained at a constant level by automatically adjusting the flow rate of the juice stream in response to a change in hold-up volume within the buffer feed tank and by automatically adjusting the flow rate of the serum stream into the one or more evaporators in response to a change in hold-up volume within said one or more evaporators.

12. A plant for the continuous production of a fruit and/or vegetable paste comprising:
a first pump comprising an inlet and an outlet;
a separator comprising an inlet that is connected to the outlet of the first pump, a high solids outlet and a low solids outlet,
a concentrator comprising an inlet and an outlet, said inlet being connected to the low solids outlet of the separator;
a second pump comprising an inlet and an outlet;
a recombinator comprising a pulp inlet that is connected to the high solids outlet of the separator, a serum inlet that is connected to the outlet of the concentrator, a dilution inlet that is connected to the outlet of the second pump, and an outlet;
an automatic controller in communication with the second pump;
a Brix concentration monitor in communication with the automatic controller;
wherein the controller automatically adjusts the throughput of the second pump in response to the output of the Brix concentration monitor.

13. A plant for the continuous production of a fruit and/or vegetable paste comprising:
a first pump comprising an inlet and an outlet;
a separator comprising an inlet that is connected to the outlet of the first pump, a high solids outlet and a low solids outlet,
a concentrator comprising an inlet and an outlet, said inlet being connected to the low solids outlet of the separator;
a recombinator comprising a pulp inlet that is connected to the high solids outlet of the separator, a serum inlet that is connected to the outlet of the concentrator and an outlet;
a second pump comprising an inlet and an outlet;
a dilutor comprising: a first inlet that is connected to the outlet of the recombinator, a second inlet that is connected to the outlet of the second pump, and an outlet;
a automatic controller in communication with the second pump;
a Brix concentration monitor in communication with the automatic controller;
wherein the controller automatically adjusts the throughput of the second pump in response to the output of the Brix concentration monitor.

14. Plant according to claim 12, wherein the Brix concentration monitor is located downstream of the recombinator.

15. Plant according to claim 12, wherein the concentrator comprises:
a buffer feed tank comprising an inlet and an outlet, said inlet being connected to the serum outlet of the separator, said buffer feed tank further comprises a level sensor in communication with the automatic controller;
a sequence of one or more evaporators, the inlet of the first evaporator being connected to the outlet of the buffer feed tank and the outlet of the last evaporator being connected to the serum inlet of the recombinator, the inlet of each of the one or more evaporators comprising a valve and each of said one or more evaporators comprising a level sensor in communication with the automatic controller;
wherein the automatic controller adjusts (i) the throughput of the first pump in response to the output of the level sensor of the buffer feed tank and (ii) the flow rate through each of the valves in response to the output of the level sensor from the evaporator immediately downstream of said valve.
